(19) United States
(12) Patent Application Publication
(10) Pub. No.: US 2004/0213318 A1
(43) Pub. Date: Oct. 28, 2004

(54) Burner and/or lance mounting assembly

(76) Inventor: Michael J. Strelbisky, Burlington (CA)

Correspondence Address: GOWLING, LAFLEUR HENDERSON LLP, SUITE 560, 120 KING STREET WEST, PO BOX 1045, LCD 1, HAMILTON, ON, L8N 3R4, CA

(21) Appl. No.: 10/781,744

(22) Filed: Feb. 20, 2004

Related U.S. Application Data
(60) Provisional application No. 60/452,500, filed on Mar. 7, 2003.

(51) Int. Cl. H05B 7/22

(52) U.S. Cl. 373/66; 373/2; 373/72

(57) ABSTRACT

A metal mounting assembly for mounting a burner or lance in a furnace has a water-cooled main body securable in an aperture in a furnace wall, a series of cooling fins extending from the main body so as to project into the furnace when secured thereto, and at least one mounting tube extending through the main body for mounting a burner or lance therein.

### RELATED APPLICATION

This invention claims priority from U.S. Provisional Patent Application No. 60/452,500 filed Mar. 7, 2003.

### FIELD OF INVENTION

This invention relates to mounting assemblies for mounting burners and/or lances in furnaces which are used to treat molten metallic material.

### BACKGROUND OF INVENTION

It is conventional to use auxiliary burners and/or lances in furnaces in which molten metallic material is treated, the burner and/or lances being carried by mounting assemblies secured in apertures in the furnace walls. Such a mounting assembly is described, for example, in U.S. Pat. No. 6,289,035 (Shver) issued Sep. 11, 2001. However, there is still a need for an improved mounting assembly which is easier to install and maintain and also is safer in use than known mounting assemblies.

It is therefore an object of this invention to provide an improved mounting assembly of this kind.

### SUMMARY OF THE INVENTION

According to the invention, a metal mounting assembly has a water-cooled main body which is securable in an aperture in a furnace wall, a series of cooling fins extending from the main body so as to project into the furnace, and at least one mounting tube extending through the main body for mounting a burner or lance therein.

The present invention permits the construction of a mounting assembly with which the likelihood of water leaking into the furnace and causing dangerous damage can be minimized.

Each mounting tube may be in heat conducting contact with at least one cooling fin, and the interior of the mounting tube may be shaped to receive the nose of a water-cooled burner in heat conducting contact therewith, whereby the burner nose cools an adjacent portion of the mounting tube.

The present invention also provides a furnace having at least one wall with an aperture therein and an inwardly projecting shelf of refractory material below the aperture, and a metal mounting assembly as described above mounted therein, the main body of the mounting assembly being located in the wall aperture and the cooling fins extending across said shelf and in contact therewith.

### DESCRIPTION OF THE DRAWINGS

Embodiments of the present invention will now be described, by way of example, with reference to the accompanying drawings, of which:

FIG. 1 is a perspective view of a portion of a furnace showing a mounting assembly in accordance with one embodiment of the invention;

FIG. 2 is an enlarged front view of part of the furnace shown in FIG. 1;

FIG. 3 is an enlarged sectional view taken along the line 3-3 of FIG. 2;

FIG. 4 is a plan view of the mounting assembly;

FIG. 5 is a front perspective view thereof;

FIG. 6 is a side view thereof;

FIG. 7 is a rear view thereof;

FIG. 8 is a front view of a mounting assembly in accordance with another embodiment of the invention;

FIG. 9 is a plan view thereof,

FIG. 10 is a sectional side view thereof showing a burner mounted therein; and

FIG. 11 is a sectional view thereof taken along the line 11-11 of FIG. 10.

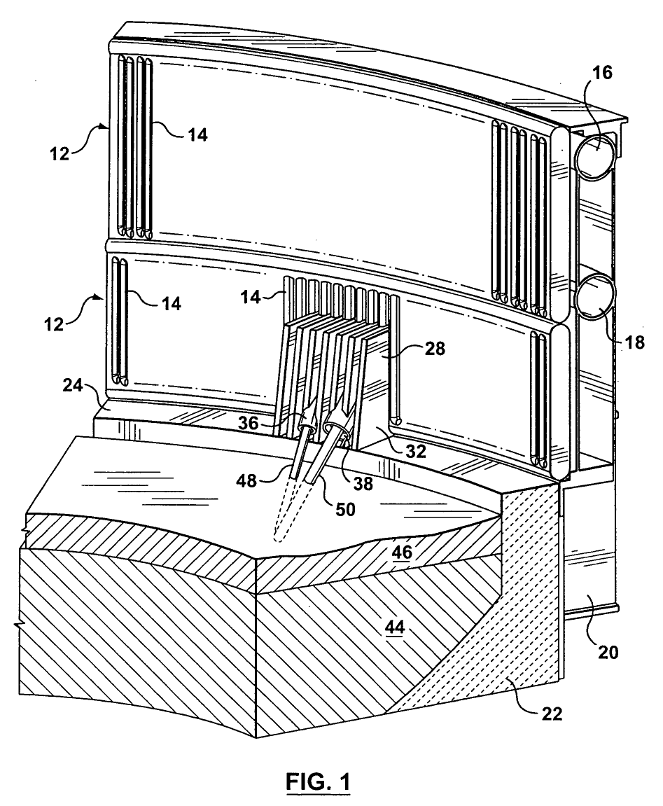

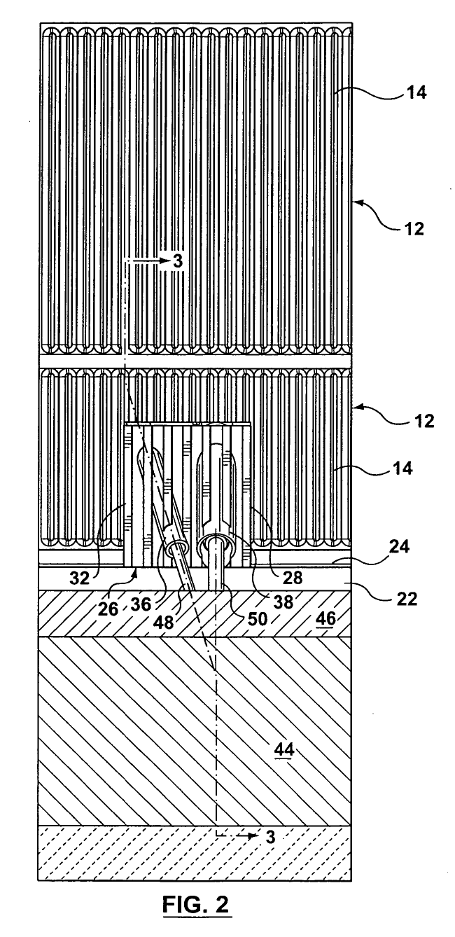

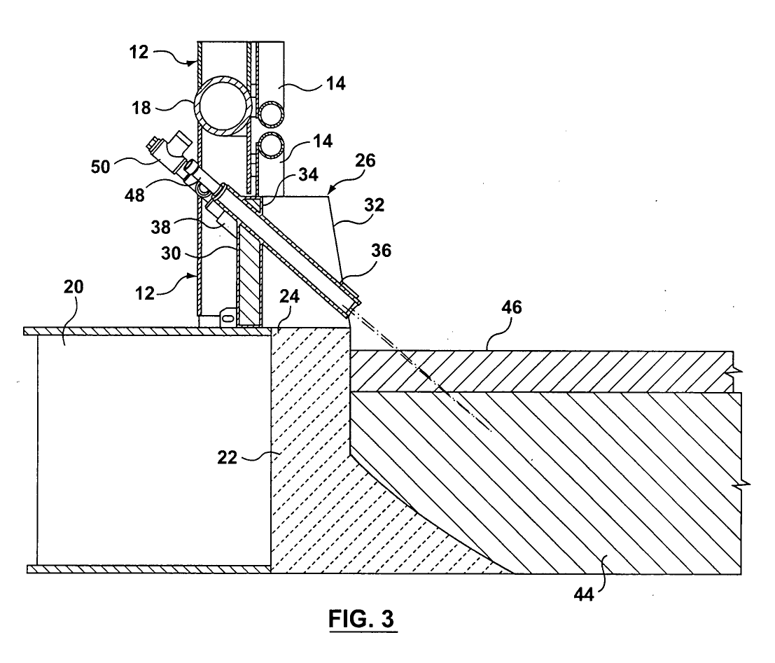

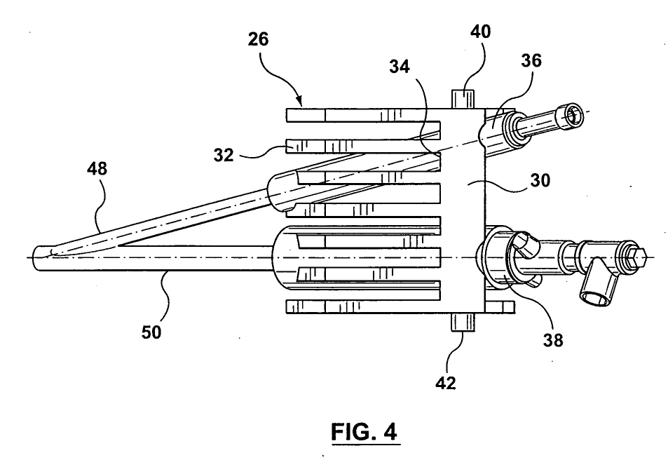

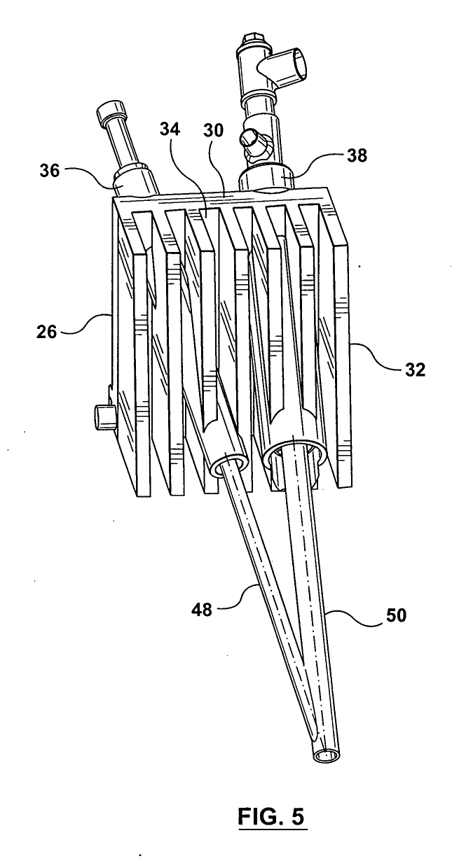

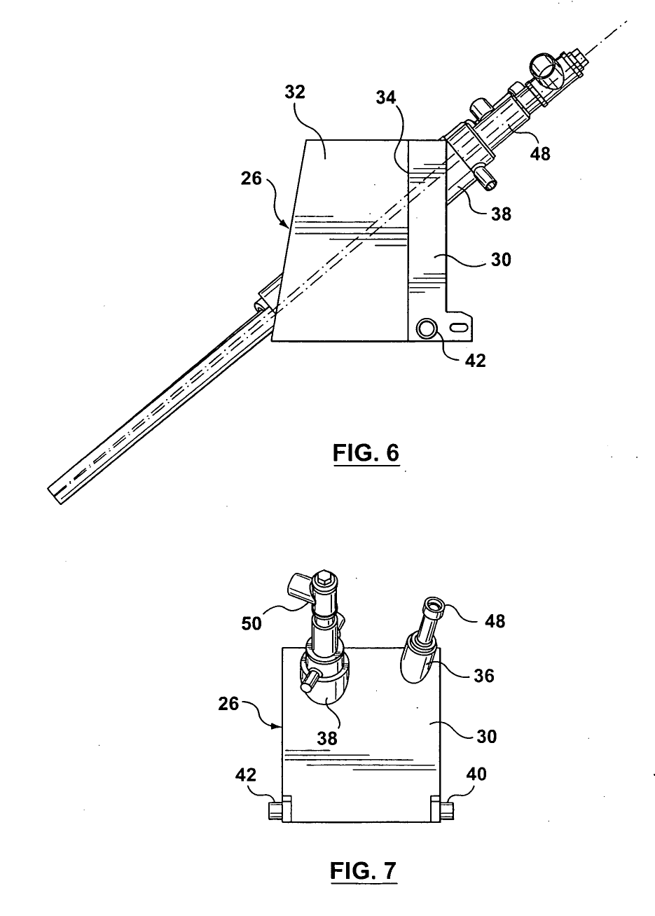

### DESCRIPTION OF PREFERRED EMBODIMENT

Referring to the drawings, an electric arc furnace has walls formed by water-cooled panels 12, the panels 12 having cooling pipes 14, an inlet header 16 to supply water to the cooling pipes 14 and an outlet header 18 which receives water which has passed through the pipes 14. The panels 12 sit on a base 20. The furnace is lined with refractory material 22, the top of which provides a shelf 24 adjacent to the bottom of the lowermost panels 12.

A metal (such as copper) mounting assembly 26 is secured by bolting or welding in an aperture 28 in a lower cooling panel 12. The mounting assembly 26 has a water-cooled vertically-extending main body 30 of rectangular section which is located in the aperture 28 in the panel 12. A series of vertically-extending laterally-spaced cooling fins 32 project forwardly from the front face 34 of the main body 30 and extend across the shelf 24 of refractory material in contact therewith.

A pair of mounting tubes 36, 38 extend in a forwardly and downwardly inclined direction through the main body 30 and the fins 32 and are suitably secured thereto so as to be in heat conducting contact therewith. The main body 30 is cooled by water passing through passages (not shown) therein. The body 30 has an inlet 40 and an outlet 42 for the supply of water to and the return of water from the passages.

In use, the furnace may contain for example molten metallic material in the form of a steel bath 44 covered by a layer 46 of slag. Necessary burners and/or lances 48, 50 (which may themselves be water-cooled) are mounted in the mounting tubes 36, 38 so that their leading ends extend into the furnace above the slag layer 46.

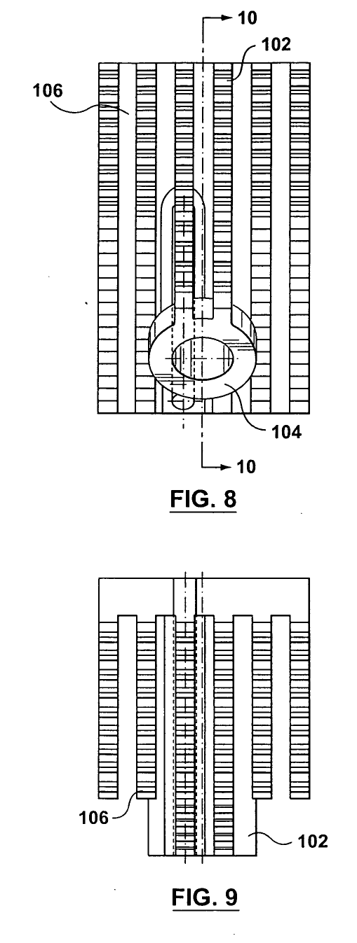

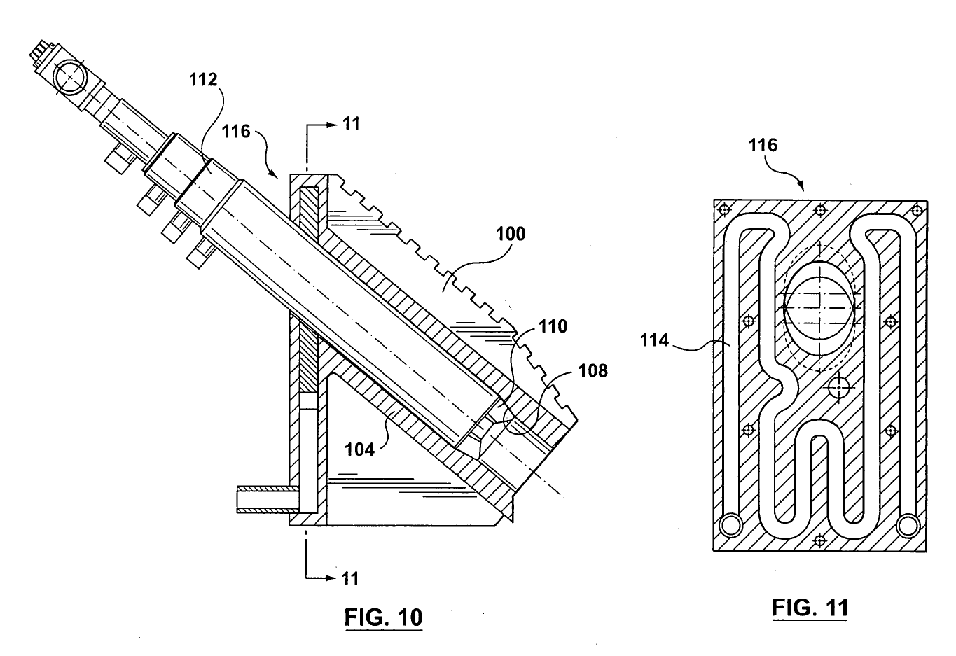

FIGS. 8 to 11 show a mounting assembly in accordance with another embodiment of the invention. In this embodiment, the cooling fins 102 adjacent to the cooling tube 104 project further forwardly than the other cooling fins 106, and the internal wall of the mounting tube 104 has a narrowing region 108 which is engaged by the tapered nose 110 of a water-cooled burner 112 mounted in the mounting tube 104. The tapered nose 110 of the burner 112 is made of a highly thermally conductive material such as copper. The burner nose 110 therefore cools the mounting tube 104 and this may be an advantage in some of the circumstances. FIG. 11 shows the cooling passage 114 in the main body 116 of the mounting assembly.

A person skilled in the art will readily appreciate the advantages of the present invention from the foregoing description of a preferred embodiment. Safety is improved because the likelihood of water leaking into the furnace and causing deterioration and possibly rupture (with consequent escape of molten material from the furnace) of the refractory material can be minimized. Also, the mounting assembly can be of relatively light weight and hence easy to install. It can also be constructed so that it is easy to repair. If desired, refractory material may be positioned between the fins, thereby increasing rigidity. Further, a mounting assembly in accordance with the present invention can be relatively inexpensive.

Other advantages and embodiments of the invention will now be readily apparent to a person skilled in the art, the scope of the invention being defined in the appended claims.

1. A metal mounting assembly for mounting a burner or lance in a furnace, said mounting assembly including:
(a) a water-cooled main body securable in an aperture in a furnace wall;
(b) a series of cooling fins extending from the main body so as to project into the furnace when secured thereto; and
(c) at least one mounting tube extending through the main body for mounting a burner or lance therein.

2. A mounting assembly according to claim 1 wherein each mounting tube is in heat conducting contact with at least one cooling fin.

3. A mounting assembly according to claim 1 wherein the interior of the mounting tube is shaped to receive the nose of a water-cooled burner in heat conducting contact therewith, whereby the burner nose cools an adjacent portion of the mounting tube.

4. A furnace having at least one wall with an aperture therein and an inwardly projecting shelf of refractory material below the aperture, and a metal mounting assembly in accordance with claim 1 mounted therein, the main body of the mounting assembly being located in the wall aperture and the cooling fins extending across said shelf in contact therewith.

5. A furnace according to claim 4 wherein each mounting tube of the mounting assembly is in heat conducting contact with at least one cooling fin.

6. A furnace according to claim 4 wherein the interior of the mounting tube of the mounting assembly is shaped to receive the nose of a water-cooled burner in heat conducting contact therewith, whereby the burner nose cools an adjacent portion of the mounting tube.
